(19) United States
(12) Patent Application Publication
(10) Pub. No.: US 2008/0139057 A1
(43) Pub. Date: Jun. 12, 2008

(54) Electrical connector

(75) Inventor: Wataru Fukuchi, Tokyo (JP)

Correspondence Address: TAKUCHI & KUBOTERA, LLP, Suite 202, 200 Daingerfield Road, Alexandria, VA, 22314, US

(73) Assignee: Hirose Electric Co., Ltd.

(21) Appl. No.: 11/987,957

(22) Filed: Dec. 6, 2007

(30) Foreign Application Priority Data
Dec. 6, 2006 (JP) 2006-329660

(51) Int. Cl. H01R 13/02

(52) U.S. Cl. 439/884

(57) ABSTRACT

An electrical connector for a circuit board is attached to one circuit board and fits to a mating connector mounted on another circuit board, so that the two circuit boards are electrically connected via a group of terminals. In the electrical connector, a housing includes an outer circumferential surface comprised of a pair of sidewall surfaces and a pair of end wall surfaces. In the electrical connector, a shielding plate is attached to the housing for covering the outer circumferential surface of the housing. The shielding plate comprises two shielding members that extend in a circumferential direction. One of the shielding members covers a part of the outer circumference of the housing, and the other shielding member covers the remaining portion. Each shielding member includes a side portion for covering one of the sidewall surfaces and an end portion for covering at least a part of the end wall surfaces.

### BACKGROUND OF THE INVENTION

The present invention relates to an electrical connector for a circuit board.

When two circuit boards, where electrical connectors are respectively attached, are connected via the connectors, a shielding plate may be attached to the connectors in order to shield and block noises inside/outside of the connectors.

For example, in Patent Reference 1, terminals are formed by bending a plurality of thin strips, which extends from one side edge of a shielding piece that functions as a shielding plate. Then, the terminals are inserted in slots formed in an insulating main body. Accordingly, the shielding piece is attached to the insulating main body for covering a side surface of the insulating main body that extends in a direction of terminal arrangement.

With the configuration disclosed in Patent Reference 1, the side surface of the insulating main body can be shielded. However, since end surfaces of the insulating main body, which are vertical to the direction of the terminal arrangement, are not covered by the shielding piece, the end surfaces are not shielded.

In Patent Reference 2, a receptacle shell is formed by bending a picture frame-like flat frame body through press molding, and works as a shielding plate. The receptacle shell is attached to the housing so as to cover an outer circumferential surface, i.e., side surfaces parallel to a direction of terminal arrangement and end surfaces vertical to the side surfaces.

In Patent Reference 3, a metallic shell is prepared by bending a strip-like member to cover an outer circumferential surface of a housing. The metallic shell has a seam in one position in a circumferential direction.

In Patent References 2 and 3, the shielding plates is attached to the housing while covering the whole outer circumferential surface of the housing. Accordingly, the whole outer circumferential surface can be shielded.

### Patent Reference 1: Japanese Patent Publication No. 2003-173847

### Patent Reference 2: Japanese Patent Publication No. 2006-202645

### Patent Reference 3: Japanese Patent Publication No. 10-106684

In Patent Reference 2, the frame body is connected at four corners thereof, and a center portion thereof is punched out to form a large window. Accordingly, the center portion punched out during the press-punching process has to be wasted, thereby lowering yield.

In Patent Reference 3, the metallic shell is formed by bending strip-like sheet metal so as to surround outer circumferential surface of the housing, thereby improving yield as opposed to the connector disclosed in Patent Reference 2. An unfolded length of the metallic shell is almost the same as that of the outer circumferential length of the housing. Accordingly, it is necessary to use a long mold to form the metallic shell, thereby lowering strength of the mold and increasing cost.

Furthermore, in Patent Reference 3, the metallic shell has the seam to be positioned on one side surface of the housing, and not to be on each of the two side surfaces that are facing to each other. In other words, the metallic shell does not have seams to be symmetrically positioned on the side surfaces of the housing. A state of space generated by the seam of the metallic shell may change by deformation of the connector by force. Accordingly, shielding properties easily change, and noises are easily generated at the seam.

Therefore, a connector having such a metallic shell has to be mounted such that the seams of the metallic shell do not face adjacent electronic components and circuits, so as not to influence each other by noise effects. Furthermore, the metallic shell does not have the seams to be symmetrically positioned on the housing. Accordingly, it is necessary to confirm whether the seams of the metallic shell do not face to electronic components and circuits, etc. near the connector upon mounting the connector, thereby causing a trouble.

In Patent Reference 3, the metallic shell has the seams to be positioned on the side surfaces parallel to the direction of the terminal arrangement, i.e., within a range of the terminal arrangement. Accordingly, noises easily leak from the terminals or enter the terminals. Furthermore, when the shielding properties change, an influence on the terminals becomes also large.

In view of the problems described above, an object of the invention is to provide an electrical connector for a circuit board, which can improve yield of a material of a shielding plate, while maintaining shielding performance.

Further objects of the invention will be apparent from the following description of the invention.

### SUMMARY OF THE INVENTION

In order to attain the objects described above, according to the present invention, an electrical connector for a circuit board is attached to one circuit board and fits to a mating connector mounted on another circuit board, so that the two circuit boards are electrically connected via a group of terminals.

In the electrical connector, a housing having a rectangular parallelepiped outer shape includes an outer circumferential surface comprised of a pair of sidewall surfaces that extend in a direction of terminal arrangement and a pair of end wall surfaces that extend in a direction perpendicular to the sidewall surfaces.

In the electrical connector, a shielding plate made of sheet metal is attached to the housing for covering the outer circumferential surface of the housing. The shielding plate comprises two shielding members that extend in a circumferential direction. One of the shielding members covers a part of the outer circumference of the housing, and the other shielding member covers the remaining portion.

Each shielding member includes a side portion for covering one of the sidewall surfaces, and an end portion bent from one end of the side portion for covering at least a part of the end wall surfaces. The shielding members are attached to the housing such that an edge of one shielding member do not contact with an edge of the other shielding member.

Each of the shielding members is preferably formed to cover one of the pair of sidewall surfaces of the housing, and to cover at least of a part of the pair of the end wall surfaces. Those shielding members are preferably attached to the housing so as to be close to each other at their edges, which are free ends, in the circumferential direction.

In the electrical connector, the two shielding members, which are formed by bending strip-type metallic members, cover almost the whole area of the outer circumferential surface of the housing, i.e., a pair of the sidewall surfaces and a pair of the end wall surfaces. The two shielding members are attached to the housing, so that the edges of one shielding member do not contact with the edges of the other shielding member, thereby forming small spaces between the edges.

In general, noises toward outside are most generated in a range where terminals are arranged, and the range is also easily affected by noises from outside. Therefore, it is necessary to shield sidewall surfaces that extend in a direction of terminal arrangement more effectively than end surfaces that extend in a direction perpendicular to the direction of terminal arrangement.

In the electrical connector according to the present invention, the shielding members are provided for covering one of the sidewall surfaces of the housing and a part of the end wall surfaces. The shielding members are arranged so that the edges of the shielding members do not get close to each other, and the edges get close to each other on the end wall surfaces of the housing. Accordingly, the edges of the shielding members do not get close to each other on the sidewall surfaces.

In other words, the shielding members completely cover the sidewall surfaces. Accordingly, shielding properties can be improved in comparison with when the edges get close on the sidewall surfaces. Furthermore, when the shielding members are attached to the housing, since the edges are close to each other without contacting, the edges do not contact even when the connector is deformed by force, thereby preventing shielding properties from lowering due to the contact from the deformation.

According to the present invention, each of the shielding members is preferably formed so as to cover almost the whole one of the pair of sidewall surfaces and one of the pair of the end wall surfaces of the housing in the circumferential directions. When the shielding members are formed in this way, the edges of the shielding members are adjacent at a position corresponding to bent sections in the circumferential direction of the housing. With this configuration, the shielding members completely cover both the sidewall surfaces and the end wall surfaces of the housing, and thereby the shielding properties can be even further improved.

According to the present invention, in the housing, each end wall surface preferably includes two surfaces that compose a step-like section along a direction perpendicular to the direction of terminal arrangement. The end portions of the shielding members preferably extend to the step-like sections.

By forming the step-like sections on the end wall surfaces of the housing, the edges of the two shielding members can be attached onto different surfaces of the end wall sections in a direction perpendicular to the direction of the terminal arrangement. Accordingly, the edges do not contact to each other even when the end portions of each shielding member deform. Therefore, the destabilization of the shielding properties due to the contact from deformation can be prevented. In addition, the ends of the shielding members extend to the step section, and the shielding members completely cover both the sidewall surfaces and the end wall surfaces of the housing. Accordingly, the shielding properties can be improved.

According to the present invention, the two shielding members preferably have an identical shape. By doing this, the two spaces between the edges formed by attaching the shielding members to the housing are symmetrically positioned. As a result, when attaching to a circuit board, even if the connector is rotated for 180° in the circumferential direction, the positions of the spaces between the edges are same as that before the rotation. Therefore, when mounting the connector onto a circuit board, a step of checking a direction of mounting the connector in view of the spaces considering influences of noises between electronic components adjacent to the connector and circuit, etc. can be omitted, so that the implementation of the connector can be easier. In addition, since the two connectors have the same shape, only one mold is necessary, so that manufacturing cost for the mold can be reduced.

According to the present invention, the shielding plate comprises the two shielding members that extend in the directions along the outer circumferential surface of the circumferential walls of the housing, and each shielding member is formed from a strip-like metallic member. Therefore, in comparison with a conventional connector, in which a shielding plate is formed from a picture frame-like flat metallic member, the yield from the originally cut-material is improved.

In addition, since an unfolded length of each shielding member is shorter than an unfolded length of the metallic member of the conventional connector, the yield from the originally cut-material is improved. Furthermore, when the unfolded length of the shielding member is shortened, a length of a mold for forming the shielding member is also shortened. Further, strength of the mold can be secured, and a manufacturing cost of the mold can be kept low.

According to the invention, since the two shielding members cover the whole outer circumferential surface of the housing, the shielding properties can be satisfactorily maintained. Especially, since the two shielding members completely cover the both sidewall surfaces that extend in the direction of terminal arrangement, the range of terminal arrangement, where leak of noises from the terminals and entry of noises to the terminals are problem, can be completely shielded. Furthermore, since the edges of the two shielding members do not contact with each other when attached to the housing, even if the connector deforms, the edges do not contact, and destabilization of the shielding properties due to the contact from deformation can be prevented.

### BRIEF DESCRIPTION OF THE DRAWINGS

FIG. 1 is a perspective view showing an electrical connector according to a first embodiment of the present invention;

FIGS. 2(A) to 2 (C) are views showing the electrical connector according to the first embodiment of the present invention, wherein FIG. 2(A) is a plan view thereof, FIG. 2(B) is a front view thereof, and FIG. 2(C) is a side view thereof;

FIGS. 3(A) and 3(B) are perspective views showing a shielding member according to the first embodiment of the present invention, wherein FIG. 3(A) is a view when the shielding member is formed, and FIG. 3(B) is a view before the shielding member is formed;

FIG. 4 is a partial view showing the electrical connector mounted on a circuit board according to the first embodiment of the present invention; and

FIG. 5 is a perspective view showing an electrical connector according to a second embodiment of the present invention.

### DETAILED DESCRIPTION OF THE PREFERRED EMBODIMENTS

Hereunder, embodiments of the present invention will be explained with reference to the accompanying drawings.

### First Embodiment

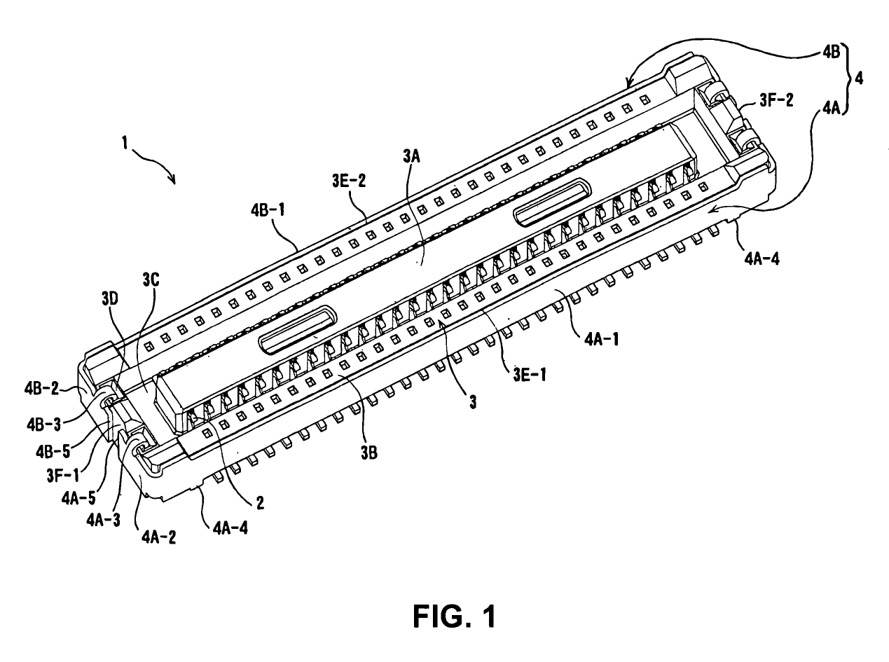

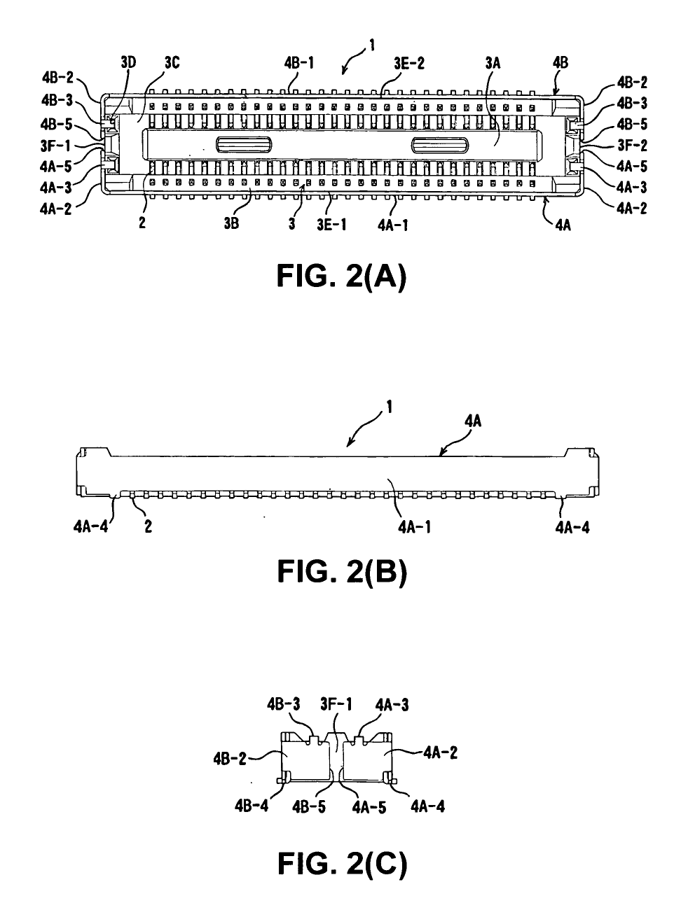

A first embodiment will be explained. FIG. 1 is a perspective view of an electrical connector 1 for a circuit board according to the first embodiment of the invention. FIG. 2(A) is a plan view of the electrical connector 1, FIG. 2(B) is a front view thereof, and FIG. 2(c) is a side view thereof.

In the embodiment, the electrical connector 1 for a circuit board (hereinafter simply referred to as “connector 1”) is attached and connected to one circuit board (not illustrated) at a bottom surface thereof. Then, by fitting to a mating connector (not illustrated) attached on the other circuit board (not illustrated), the circuit boards are electrically connected via terminal groups of the respective connectors.

In the connector 1, a plurality of terminals 2, which contacts with terminals of the mating connector, is held in a housing 3, and shielding plates made of metal are attached to an outer circumferential surfaces of the housing 3.

As shown in FIGS. 1 and 2(A), the housing 3 is rectangular parallelepiped, and has an island-like protruding section 3A and circumferential walls 3B. The circumferential walls 3B surround the protruding section 3A and form the outer circumference of the housing 3. A receiving section 3C, which is opened upward and dented, is formed between the protruding section 3A and the circumferential walls 3B so as to surround the protruding section 3A. The receiving section 3C works as a space to receive the mating connector therein.

The housing 3 holds the plurality of terminals 2, which is arranged in two rows at equal intervals in a longitudinal direction of the connector 1, with the protruding section 3A and the circumferential walls 3B. Both ends of the circumferential walls 3B in the direction of the terminal arrangement have two holes 3D each in the upper surfaces, which are opened upward in a direction vertical to the direction of the terminal arrangement.

The housing 3 has outer circumferential surfaces, which are comprised of a pair of sidewall surfaces 3E-1 and 3E-2 (hereinafter, both together are referred to as “sidewall surfaces 3E”), which extend in the longitudinal direction, i.e. the direction of the terminal arrangement, and a pair of end wall surfaces 3F-1 and 3F-2 (hereinafter, both together are referred to as “end wall surfaces 3F”), which extend in a direction vertical to the sidewall surfaces 3E.

In the embodiment, the shielding plates 4 made of sheet metal are attached to the housing 3, so as to cover the outer circumferential surfaces of the housing 3. The shielding plates 4 include two shielding members 4A and 4B, which have same shape.

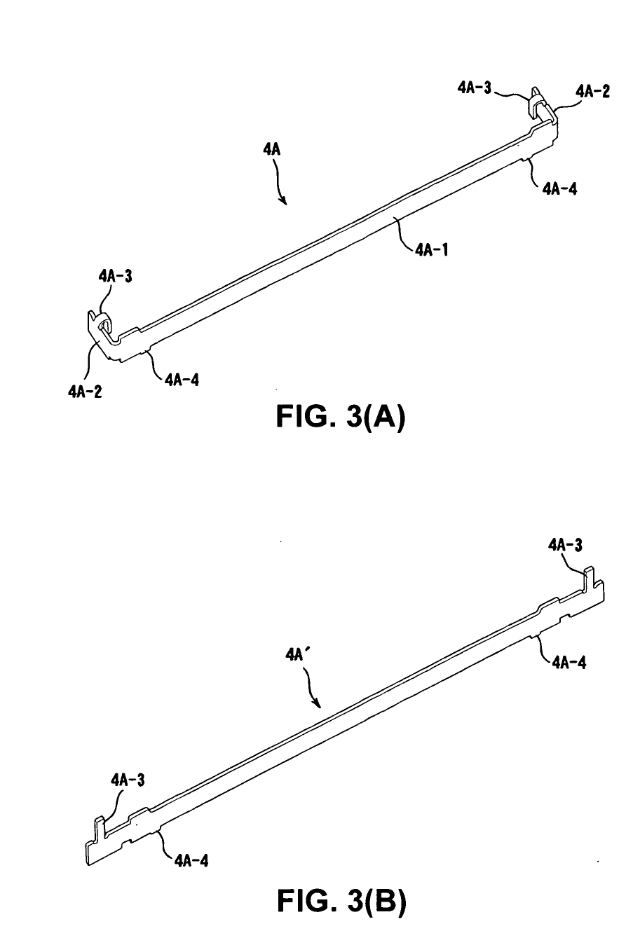

FIG. 3(A) is a perspective view of the shielding member 4A; and FIG. 3(B) is a perspective view of the shielding plate 4A′ which is partially fabricated before bending. The shielding member 4A is shaped, so that the both ends of the shielding member 4A in the longitudinal direction are vertically bent.

As shown in FIG. 3(B), the shielding member 4A is formed by vertically bending a strip-like sheet metal, which has the same width as height of the connector 1, to the plate surface at two positions in the same direction. The shielding member 4A formed in this way has a side section 4A-1, which extends in the longitudinal direction, and two end sections 4A-2, which extend in a direction vertical to the longitudinal direction.

In the embodiment, a length of the side section 4A-1 in the longitudinal direction is the same as that of the sidewall surfaces 3E, and a length of the end section in a direction vertical to the longitudinal direction of the side section 4A-1 is slightly shorter than a half length of the end wall surfaces 3F of the housing 3 in a direction vertical to the terminal arrangement.

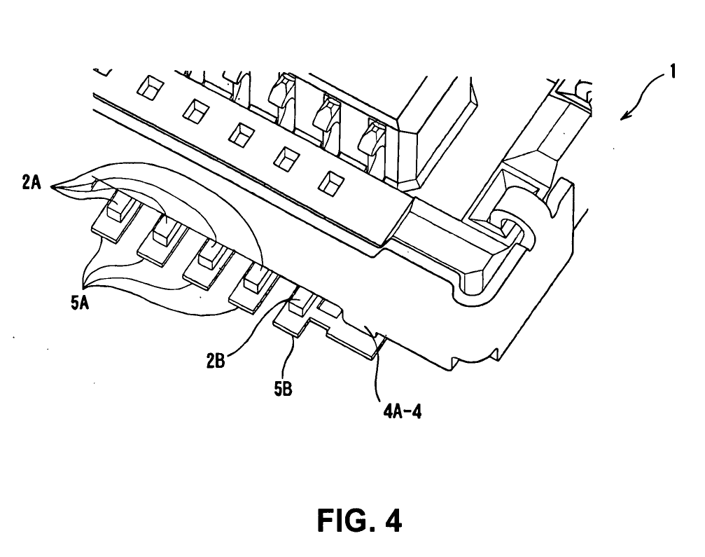

Thin arms extend from the respective upper edges of the two end sections 4A-2 and bent to inverse U-shape so as to face each other, and have locking sections 4B-3 for attaching to the housing 3. Furthermore, as shown in FIGS. 1, 2(B), and (C), legs 4A-4 are formed at two positions on the lower edge of the side section 4A-1. Connection of the legs 4A-4 to a grounding pattern will be described later, referring to FIG. 4.

The shielding member 4B is also formed by a similar procedure from sheet metal of the same shape as that of the shielding member 4A, and has an identical shape to that of the shielding member 4A. As shown in FIGS. 1, 2(A) and 2(C), the shielding member 4B has a side section 4B-1, end sections 4B-2, locking sections 4B-3, and legs 4B-4.

In this embodiment, since the shielding plates comprise two shielding members, a unfolded length of each shielding member is shorter than a length when the shielding plate is formed from one strip-like sheet metal, so that the yield from the originally-cut material is improved, and thereby the strength of the mold can be secured and the cost for the mold can be kept low. Furthermore, to form the shielding members having the same shape, only one mold is required for forming such shielding members, and thereby the manufacturing cost for the mold can be kept low.

The shielding plates 4 are attached to the housing 3, so that the shielding member 4A covers the outer circumferential surfaces of the housing 3 at one side, and the shielding member 4B covers the other side. More specifically, as shown in FIG. 1, the shielding member 4A is attached to the housing 3 by respectively inserting two locking sections 4A-3 in the holes 3D in both ends of the housing 3 in the longitudinal direction. By doing this, the side section 4A-1 of the shielding member 4A covers the sidewall surface 3E-1 of the housing 3, and the two end sections 4A-2 of the shielding member 4A cover almost a half of the end wall surfaces 3F-1 and 3F-2 of the housing 3.

The shielding member 4B is attached to the housing 3 by inserting two locking sections 4B-3 in another holes 3D in both ends of the housing 3 in the longitudinal direction. By doing this, the side section 4B-1 of the shielding member 4B covers the sidewall surface 3E-2 of the housing 3, and the two end sections 4B-2 of the shielding member 4B covers almost a half of the end wall surfaces 3F-1 and 3F-2 of the housing 3.

As described above, in the embodiment, when the shielding members 4A and 4B are attached to the housing 3, the shielding plates 4 cover almost all the outer circumferential surfaces of the housing 3. Therefore, the shielding properties are satisfactory.

In the embodiment, when the shielding members 4A and 4B are attached to the housing 3, the shielding member 4A and the shielding member 4B are adjacent to each other at the free ends, having a certain distance away from each other. More specifically, the edge 4A-5 of the shielding member 4A and the edge 4B-5 of the shielding member 4B are close to and face each other.

As described above, since the lengths of the side sections 4A-2 and 4B-2 are slightly shorter than a half length of the end wall surfaces 3F, there are spaces formed between the edges 4B-5 and the edges 4A-5. When the spaces are formed between the edges, the edges do not contact even if the connector is deformed, and destabilization of the shielding properties due to contact of the edges from deformation of the connector can be avoided. In addition, since problems of leaks and entry of noises are less at the end wall surfaces 3F, in comparison with the sidewall surfaces 3E in the range where the terminals are arranged, the above-described spaces do not affect the shielding properties so much.

Furthermore, since the shielding member 4A and the shielding member 4B have the same shape, when the shielding member 4A and the shielding 4B are attached to the housing 3, the two spaces between the edges are symmetrically positioned as shown in FIG. 2(A). Accordingly, upon mounting the connector 1 on a circuit board, a step of checking the direction to mount the connector 1 to determine which direction to direct the spaces can be omitted. As a result, such a step of checking the position is unnecessary and thereby the work of mounting the connector 1 can be easier in comparison with when the spaces between terminals are asymmetrically positioned due to a shape of the shielding members and an attachment position of the connector.

The connector of the above-described constitution is mounted on a circuit board by procedures described below, and then connected to the mating connector.

First, the connector 1 is mounted on a circuit board. FIG. 4 shows a part of the connector 1 mounted on a circuit board. The connector 1 is disposed on the circuit board. Then, the plurality of terminals 2, the legs 4A-4 of the shielding member 4A, and the legs 4B-4 of the shielding member 4B are connected by soldering to signaling patterns 5A or grounding patterns 5B (hereinafter, the signaling patterns 5A and the grounding patterns 5B together may be also referred to as “patterns 5”) on the circuit board. FIG. 4 shows a state where a part of the plurality of terminals 2 and the legs 4A-4 connect to the patterns 5. Here, since connection of the legs 4B-4 of the shielding member 4B can be also explained similarly to the legs 4A-4, the explanation thereof is omitted.

In this embodiment, the plurality of terminals 2 includes signaling terminals 2A and grounding terminals 2B. As an example, the terminals located at both ends of the plurality of terminal arranged thereon are used as the grounding terminals. In mounting the connector 1, each signal terminal 2A is connected by soldering to individual signal pattern 5A. On the other hand, the grounding terminals 2B are connected by soldering to the grounding patterns 5B. As shown in FIG. 4, the legs 4A-4 of the shielding member 4A are also connected by soldering to the grounding patterns 5B. In other words, each grounding terminal 2B and each leg 4A-4 share one grounding pattern 5B.

As described above, an area of the pattern used for grounding on the circuit board can be reduced through connecting the grounding terminals 2B and the legs 4A-4 of the shielding member 4A to the same grounding patterns 5B. Accordingly, the space on the circuit board can be saved for another circuit for a different purpose. Therefore, a degree of freedom for pattern layout on the board can be increased.

In addition, as described above, the grounding terminals and the legs of the shielding member are respectively connected to the same grounding patterns, and the grounding terminals are not directly connected to the shielding members. Therefore, there is not a problem of destabilization of shielding properties due to direct contact between the grounding terminals and the shielding member. In addition, since it is not necessary to separately provide a member to contact the grounding terminals and the shielding member, the structure of the connector can be simplified.

In the embodiment, among the plurality of terminals 2 arranged in the connector, the terminals at both ends are used as the grounding terminal. The grounding terminals do not have to be the terminals arranged at both ends. Even when terminals other than the terminals at both ends are used as the grounding terminals, by connecting the grounding terminals and the legs of the shielding member to the same grounding pattern, the space on a circuit board can be saved.

After mounting the connector 1 on the circuit board, by fitting the mating connector mounted on another circuit board in a receiving section 3C so as to contact the terminals 2 of the connector 1 with terminals of the mating connector, the two circuit boards are electrically connected to each other.

In the embodiment, the shielding members 4A and 4B are formed by bending both ends of a strip-like sheet metal. Alternatively, the shielding member may be formed in a L-shape. In this case, the shielding member is formed so as to cover almost all the area of one sidewall surface and one end wall surface of the housing. By forming the shielding member in this way, the edges of the shielding member are close to each other at positions corresponding to bent sections in the circumferential directions of the housing, having space between them. By doing this, the shielding members completely cover both the sidewall surfaces and the end wall surfaces of the housing without leaving any space, and the shielding properties can be even more improved.

In the embodiment, when the connector 1 fits to the mating connector, during the fitting, both connectors are completely shielded with the shielding plates 4 of the connector 1. Therefore, a size of the mating connector can be reduced, and the space on a circuit board can be saved for another circuit for a different purpose, and the degree of freedom for circuit layout will be also increased.

As described above, in the embodiment, since it is not necessary to provide a shielding plate on the mating connector, the shielding plates 4 of the connector 1 do not have to be formed, considering the contact with a shielding plate of the mating connector.

For example, it is not necessary to form a spring-like contact section for contact by spring-like action with the shielding plate of the mating connector by cutting and lifting a part of the shielding members 4A and 4B of the connector 1. As a result, the shielding plate does not have to be formed of a spring material, and the shielding members 4A and 4B can be formed to have a large thickness. Furthermore, since the shielding members 4A and 4B are not formed of a spring material, which is an expensive material, the material cost can be saved.

As described above, it is not necessary to form a contact section that contacts by spring-like action with the shielding plate of the mating connector by cutting and lifting a part of the side section or end sections of the shielding members 4A and 4B of the shielding plate 4. Accordingly, the side sections and the end sections of the shielding members 4A and 4B do not have to have holes for cutting and lifting. Therefore, the shielding members 4A and 4B completely cover the sidewall surfaces 3E and the end wall surfaces 3F of the housing 3. As a result, incomplete shielding at the holes would not occur, and satisfactory shielding properties can be secured.

Furthermore, in the embodiment, it is not necessary to provide a shielding plate on the mating connector. Accordingly, it is not necessary to consider contacting the grounding terminals of the connector 1 to the shielding plate of the mating connector. Therefore, there is no such a problem as destabilization of the shielding properties due to direct contact between the grounding terminals and the shielding plate. In addition, since there is no need to provide a member to contact the grounding terminals to the shielding plate of the mating connector, the structure of the connector 1 can be simplified.

### Second Embodiment

A second embodiment of the present invention will be explained next. In the first embodiment, each end wall surface has one flat surface. On the other hand, in the second embodiment, end wall surfaces have step-like shapes. In the embodiment, only differences from the first embodiment will be mainly described.

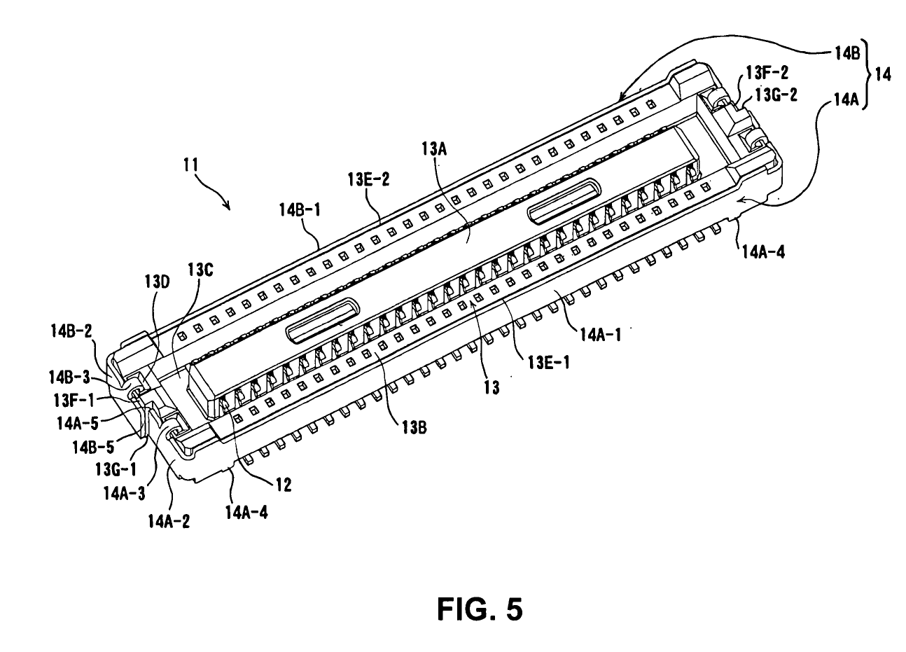

FIG. 5 is a perspective view of a connector 11 according to the second embodiment of the present invention. In FIG. 5, parts corresponding to those in the first embodiment are denoted with reference numerals of the reference numerals in the first embodiment plus 10.

As shown in FIG. 5, in a housing 13 of the connector 11, end wall surfaces 13F-1 and 13F-2 respectively include uneven surfaces in a direction vertical to the direction of terminal arrangement. Accordingly, respective two surfaces form step-like sections 13G-1 and 13G-2 (hereinafter those two sections together are referred to as “step-like sections 13G”). Here, the step-like section 13G is positioned in a center in a direction vertical to the direction of terminal arrangement on the end wall surface 13F.

In the embodiment, lengths of an end section of a shielding member 14A and an end section of a shielding member 14B are equal to a half of a length of an end wall surface 13F, which differs from the first embodiment, in which the length of the end section of the shielding member is slightly shorter than half the length of the edge wall surface.

When the shielding members 14A and 14B having a same shape are attached to the housing 13, the end sections of the shielding member 14A and the end sections 14B-2 of the shielding member 14B extend to the step-like sections 13G, and the whole end wall surfaces 13F are covered. At this time, since there is no space formed between the edges 14A-5 of the shielding member 14A and the edges 14B-5 of the shielding member 14B in a direction vertical to the direction of terminal arrangement, shielding plates 14 completely covers the outer circumferential surface, and thereby satisfactory shielding properties can be achieved.

As shown in FIG. 5, the edge 14A-5 of the shielding member 14A and the edge 14B-5 of the shielding member 14B have uneven surfaces in a direction vertical to the direction of the terminal arrangement. Therefore, even when the connector is deformed, the edges do not contact with each other, and therefore destabilization of the shielding properties due to contact from the deformation can be prevented.

The disclosure of Japanese Patent Application No. 2006-329660, filed on Dec. 6, 2006, is incorporated in the application by reference.

While the invention has been explained with reference to the specific embodiments of the invention, the explanation is illustrative and the invention is limited only by the appended claims.

What is claimed is:

1. An electrical connector to be connected to a mating connector, comprising:
a housing having a pair of sidewall surfaces and a pair of end wall surfaces;
a plurality of terminal disposed in the housing;
a first shielding member having a first side plate portion covering one of the sidewall surfaces and a first end plate portion covering a part of the end wall surfaces; and
a second shielding member having a second side plate portion covering the other of the sidewall surfaces and a second end plate portion covering another part of the end wall surfaces, said second end plate portion being away from the first end plate portion.

2. The electrical connector according to claim 1, wherein said first end plate portion is arranged to cover a first portion of both of the end wall surfaces, and said second end plate portion is arranged to cover a second portion of both of the end wall surfaces.

3. The electrical connector according to claim 1, wherein said first shielding member further includes a first end portion attached to the housing, and said second shielding member further includes a second end portion attached to the housing adjacent to the first end portion.

4. The electrical connector according to claim 1, wherein said first shielding member is arranged to cover substantially a whole area of one of the end wall surfaces, and said second shielding member is arranged to cover substantially a whole area of the other of the end wall surfaces.

5. The electrical connector according to claim 1, wherein said housing further includes a step portion on least one of the end wall surfaces, said first end plate portion and said second end plate portion extending to the step portion.

6. The electrical connector according to claim 1, wherein said first shielding member has a shape same as that of the second shielding member.
